(19) United States
(12) Patent Application Publication
(10) Pub. No.: US 2001/0051885 A1
(43) Pub. Date: Dec. 13, 2001

(54) System and methods for requesting, qualifying, approving and confirming reservation contracts

(76) Inventors: James R. Nardulli, Boulder, CO (US); Kelly B. Corkill, Boulder, CO (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/792,465

(22) Filed: Feb. 23, 2001

Related U.S. Application Data
(60) Provisional application No. 60/184,811, filed on Feb. 24, 2000.
(60) Provisional application No. 60/252,348, filed on Nov. 20, 2000.

(51) Int. Cl. G06F 17/60

(52) U.S. Cl. 705/6; 705/5

(57) ABSTRACT

A system and method for qualifying parties to a reservation contract is presented. The system and method preferably comprises a computer networked system for providing detailed information to consumers and service providers about the reliability of the consumer and/or service provider. The information may comprise a letter grade that describes the degree to which it is likely that either party will perform in accordance with the terms of a proposed reservation commitment. The invention presented renders it possible that the individual parties—consumer and service provider alike—may qualify prospective corresponding parties using the pre-analyzed product of historic performance data acquired and accrued over time and from a plurality of peer sources.

This application claims the benefit of U.S. Provisional Application No. 60/184,811 entitled “SYSTEM AND METHODS FOR REQUESTING, QUALIFYING, APPROVING AND CONFIRMING RESERVATION CONTRACTS” (Attorney Docket No. 019349-000100US), filed on Feb. 24, 2000 and U.S. Provisional Application No. 60/252,348 entitled “SYSTEMS AND METHODS FOR RESERVING INVENTORY” (Attorney Docket No. 019349-000300US), filed on Nov. 20, 2000.

### BACKGROUND OF THE INVENTION

The present invention relates generally to an online, electronic reservation system, and more particularly to a reservation system that has the capability of pre-qualifying parties prior to making a reservation.

Restaurants, hotels, car companies, golf courses, and other entertainment and service venues operate in large measure by way of advanced reservations. Consumers find it essential to manage and plan business and personal travel, dining, and other entertainment activities through the use of reservations made in advance. It is somewhat common for hotels to obtain a consumer's credit card information as a form of guarantee that a consumer will perform in accord with the terms of a reservation. However, rental car companies and restaurants have not found it to be compatible with their business circumstances to acquire or require credit card guarantees from consumers who wish to make reservations.

Hotels, rental car companies and restaurants each share common circumstances in that their ability to generate revenue is controlled and limited by the number of rooms, cars or tables available. Advance reservation is the preferred method by which service providers plan and manage peak service periods. A primary aspect of the art of balancing supply with demand, thus, may be defined as the degree to which the restaurant manager may rely upon the performance of the consumer in regard to a reservation commitment.

For service providers, certain data is easily and reliably known. For example, such reliably known information may include the number and types of rooms, cars or tables and chairs available at a date and time certain. Other data can be extrapolated from historical experience, such as the length of time guests are likely to occupy a table in a restaurant. Computer technology has made the collection, correlation and use of such data commonplace among the service providers.

As an example, a restaurant manager knows that his restaurant has 100 seats arranged around 25 tables. He also knows that the restaurant is open for five hours during a particular service period, and that the average time a table is occupied by guests is two hours. Thus it is possible to plan a service period during which a maximum of 50 guests per hour may be seated. This information controls and limits the number of reservations that may be accepted. When the theoretical maximum number of reservations has been accepted, no further reservations can be taken. Any reservation requests made for a time and date that has been fully reserved must be declined, in order to ensure that a table will be available for each reservation accepted.

As the service period that has been fully reserved begins, potential patrons arrive or telephone with the intent of dining without the benefit of a reservation made in advance. The restaurant manager is unable to accommodate such potential patrons, and thus, business revenue is declined. Unfortunately, however, the incidence of consumers failing to present themselves at the restaurant at or about the time reserved is commonplace. The result of this “no-show” consumer's failure to honor his/her reservation commitments is an industry wide problem that has had significant and egregious impact upon the service provider restaurant, and upon the service staff employees of the restaurants, who suffer substantial monetary loss due to the loss of gratuities. In order to demonstrate the economic impact of this problem, consider the following example.

A party of eight has a reservation for 6:30 p.m. Because a typical party of eight requires two tables, each capable of accommodating four people, and because it is known that the average time diners occupy a table is two hours, two tables must be reserved from opening time at 5 p.m. until 6:30 p.m. It is customary and reasonable to allow a 15-minute “grace” period from the time reserved, in this case 6:30, to allow for any minor delays that the reserving party may encounter. At 6:45, the reserving party becomes a “no-show,” and efforts are made to utilize the reserved tables. The financial impact of the “no-show” can be demonstrated by considering that the two tables held for the reserving party represent 12.5 percent of the seating capacity of the restaurant. The best case is that these two tables can be seated once each during the time remaining in the service period, rather than twice each as would have been possible had the reserving party not made the initial reservation request. Thus, a single no-show party, as in this example, reduces the revenue generating potential of the restaurant by 6.25 percent during that service period.

The restaurant industry estimates that the incidence of “no shows” may be as high as 25 percent of all reservations made. Thus, it is apparent from the example that the economic impact can be huge.

A number of other solutions, such as the previously discussed credit card guarantee method, have been implemented. However, consumers often are not willing to offer a credit card number over the telephone and, in fact, many restaurants are prohibited from engaging in over-the-phone credit card commerce as a condition of a credit card acceptance contract. In order for the credit card guarantee method to be effective, a written agreement must be executed, detailing the terms of the guarantee and requiring that the consumer evidence his acceptance of the agreement by, for example, signing the agreement. Thus, it is clear that the credit card guarantee system is not a very good solution to the problem.

A second solution to the problem (one that is being increasingly adopted by restaurants) is to discontinue acceptance of reservations altogether. While this is a solution to the problem, it creates other problems. For example, consumers have a tendency to react negatively to “no reservation” policies, and restaurant managers cannot plan appropriately for given service periods.

A third solution to this problem is to maintain a record-keeping system to store data, on an individual service provider basis, that tracks the occurrences of “no shows” correlated by name, telephone number, or both, in order to provide the restaurant manager with some basis to determine the degree to which it is likely that a guest attempting to make a reservation will honor that reservation. This solution is inadequate because it is limited to information obtained by individual restaurants and to guests who have previously made reservations at that individual restaurant.

Thus, what is needed is a system and method of pre-qualifying parties prior to setting a reservation for those parties.

### SUMMARY OF THE INVENTION

In accordance with the present invention, systems and methods for qualifying parties to a reservation contract is presented. The systems and methods comprise a computer networked system for providing detailed information to users and service providers about the reliability of the user (for example, a consumer) and/or service provider. The invention presented renders it possible that the individual parties—user and service provider alike—may qualify prospective corresponding parties using the pre-analyzed product of historic performance data acquired and accrued over time and from a plurality of sources. The present invention further comprises a methodology to track and infer qualifications across a user base, and thereby provide associative recommendations to both sides of the proposed reservation as to the likelihood of the compliance with the terms of reservation commitments of the parties.

The system and method in accordance with the present invention is able to construct a reliability factor which describes the propensity of a given party to act in accord with the terms of a reservation commitment through the acquisition, mathematical analyses, storage, correlation and retrieval of historic performance data.

One embodiment of a method according to the present invention comprises obtaining reliability data for a first entity from at least a second entity. A central computer system calculates a reliability factor based on the reliability data. The reliability factor is communicated to a third entity. In some embodiments, the first entity is a user, and the second and third entities are service providers. In other embodiments, the first entity is a service provider, and the second and third entities are users.

Another embodiment of a method according to the present invention includes assigning table reservations in a restaurant. The method comprises receiving a request for a table reservation and a reliability factor, both associated with the user. The reliability factor is derived from input from a plurality of restaurants. Based at least in part on the reliability factor, the request for a table reservation is accepted.

Yet another embodiment of a method according to the present invention includes assigning reservations for inventory maintained by a service provider. The method comprises receiving a request to reserve an inventory item from a user and providing the request to a service provider associated with the inventory item. In addition, the method comprises providing a reliability factor associated with the user which is derived from input from a plurality of service providers. A response to the request to reserve the inventory item is also received from the service provider.

An embodiment of a system according to the present invention is useful for determining the reliability of a consumer and/or a service provider. The system comprises a central computer system which is associated with a database comprising a first reliability factor associated with a service provider and a second reliability factor associated with a consumer. The first reliability factor is derived from input from a first plurality of entities and the second reliability factor is derived from input from a second plurality of entities. The computer system is accessible to both the consumer and the service provider.

These and other embodiments of the present invention are described in more detail in conjunction with the text below and attached figures.

### BRIEF DESCRIPTION OF THE DRAWINGS

FIG. 1 is an overall functional diagram of one embodiment of a system in accordance with the present invention;

FIG. 2 is a flow diagram illustrating a method in which a consumer researches the stored qualifications of one or more service providers;

FIG. 3 is a flow diagram illustrating a method in which a consumer initiates a reservation request to one or more of the service providers;

FIG. 4 is a flow diagram illustrating a method for completing a reservation agreement between a consumer and a service provider;

FIG. 5 is a flow diagram illustrating a method for acquiring historical performance data from consumers and service providers; and

FIG. 6 is a flow diagram illustrating a method for canceling previously made reservations.

### DESCRIPTION OF THE SPECIFIC EMBODIMENTS

The present invention pertains to a novel computer system and method for acquiring historical performance data relating to the reliability of consumers and service providers, analyzing that data by way of proprietary formulas and methods, and then presenting recommendations based upon such analyzed data, to both parties of a proposed reservation. The recommendations may comprise recommendations on whether a consumer should choose a certain service provider, and/or whether a service provider should take a reservation from a consumer. The system comprises a computer network, such as the Internet, a direct dial network, or the like, to which a plurality of consumers and service providers can access from remote locations through the use of computer devices, such as personal computers, hand-held computers, cell phones, or other similar electronic devices that provide for the transmission and reception of data. Of course, it should be recognized by one of ordinary skill in the art that a number of communication means and/or networks can be used in accordance with the present invention. For example, a composite communication device comprising a cell phone and pager can be used in accordance with the present invention. Additionally, various networks including a wireless Internet or cellular network can be used.

The reliability checking, data collection, and reservation system of the present invention comprises a central site server having software, which provides a means of acquiring and formulating historical performance data and serves as a repository for continuously updated actuary-like information gathered over time by capturing data generated by consumers requesting and service providers confirming reservations through use of an interactive computerized network. Both consumers and service providers are automatically and electronically queried concerning the opposite parties' compliance and performance with recent reservation commitments. This data is correlated by central site software, which comprises one or more algorithms for calculating the number of times a consumer or service provider performed as agreed, as a weighted percentage of either total reservations made or the total number of reservations accepted. This percentage can be correlated to a letter grade, which letter grade is displayed to both parties prior to requesting or accepting reservations. Alternatively, the percentage can be correlated to a numerical or other grade. For example, the grade may be indicated as a number of stars with a higher number of stars indicating a higher rating.

By using this rating, the consumer knows the degree to which it is likely that a service provider will have a table ready at the reserved time. Similarly, a service provider will have available reliable information relating to the degree to which it is likely that a requesting consumer will honor his reservation commitment. No punitive measures or actions are required. Each participant's own performance creates and controls his own cumulative rating.

The reliability checking and reservation system and methodology of the present invention function as a type of performance rating that serves equally for both sides of the transaction. Because of the bilateral or multilateral quality of the system, a service provider's or consumer's reliability rating will be an increasingly useful means of conducting business.

In some embodiments of the present invention, a consumer and/or provider can be provided a means for correcting errors in the system. For example, where a consumer mistakenly suggests that a particular provider had poor service in relation with a particular reservation, the consumer can be allowed to unilaterally correct the misinformation. Alternatively, where a negative comment is correct, but the parties to the transaction later resolve their differences, some embodiments provide for updating the information to reflect the resolution of any differences. For example, a consumer who was provided poor service by a service provider may agree to change a negative comment in exchange for a gift certificate. Alternatively, a service provider that left a negative comment because a consumer failed to honor a reservation may agree to remove the negative comment in exchange for a payment from the consumer to cover at least some of the lost profits of the service provider.

In accordance with one embodiment of the present invention, the central site server may be connected to a plurality of service providers and consumers via the Internet or World Wide Web. In addition, other wired or wireless communication connections, such as direct dial-up or other networking connections, may be used. Among the information that may be available to consumers is menus, location information, hours of operation, key personnel information and biographies, the reliability system rating of the service provider, and other relevant data. Should a consumer wish to request a reservation at a particular service provider, the consumer automatically would be directed to a certain area of a service provider's Internet domain or to a separate but related Internet domain where the consumer would be prompted for a pre-existing username and pin, or prompted to establish a new username and pin. Either event would trigger the creation or annotation of a reliability system data record unique to the username and pin. This data record would be updated each time information concerning the user was present within the system.

Additional information available to service providers can include the average amount of time spent at a table during a meal. This information can be weighted depending upon the cost of the meal to determine the average cost per amount of time spent dining. Also, the percentage of tips given by a consumer and the types of meals ordered by the consumer may also be maintained. In some embodiments, this additional information is combined with a consumer's reliability rating. Thus, for example, a consumer which frequently fails to honor a reservation may still enjoy a relatively high rating where the consumer is associated with a high average cost per amount of time or consistently leaves substantial tips. In other embodiments, this additional information is provided separate from any rating. Thus, for example, a service provider may be provided with both the consumer's reliability rating and the consumer's spending habits. The service provider can then make a judgment on whether to accept a reservation based on both the reliability rating and spending habits. In some embodiments, a consumer's rating may be sufficiently low that a service provider will decline all reservation requests from the consumer or may require a credit card confirmation before the request will be granted. In other embodiments, a consumer may enter their credit card information in which case, they are automatically given a high rating.

In some embodiments, any information related to the consumer's spending habits is maintained confidential to the service provider. Thus, for example, reliability information about whether or not a consumer honors reservations is received from a number of service providers and the rating formed from the received information is provided to any requesting service provider. However, aggregated information received from a service provider related to the spending habits of a consumer is accessible only to the providing service provider. This advantageously maintains some of the service provider's information secret.

In other embodiments, any information provided to the system is only available in an aggregate form. Thus, a requesting party is unable to determine the exact information underlying a rating. This encourages the production of candid information relating to both service providers and consumers. Of course, however, some recourse for must be provided to discourage production of defamatory information.

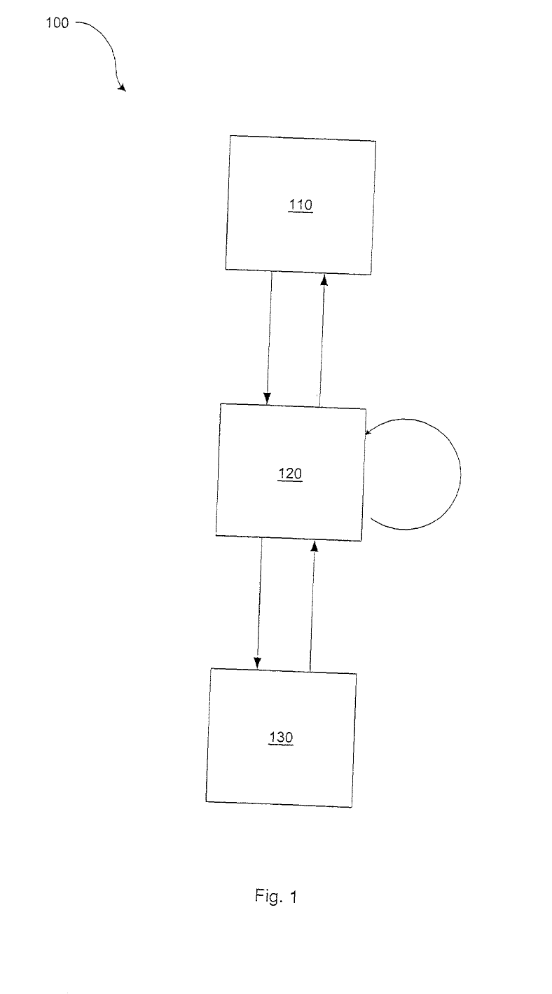

Referring now to FIG. 1, an overall functional diagram 100 of one embodiment of the system of the present invention is shown. The invention provides a unique communication network connecting consumers 110, and service providers 130 through an intermediary analytical system 120, and allows an anonymous exchange of information that qualifies both parties to the negotiated reservation. The intermediary analytical system 120 may comprise a central site server and database, or a network of servers and databases. Consumers 110 and service providers 130 are connected to the intermediary analytical system 120 via communication connections, such as the Internet, a dial-up connection, wireless connections, other network connections, or the like.

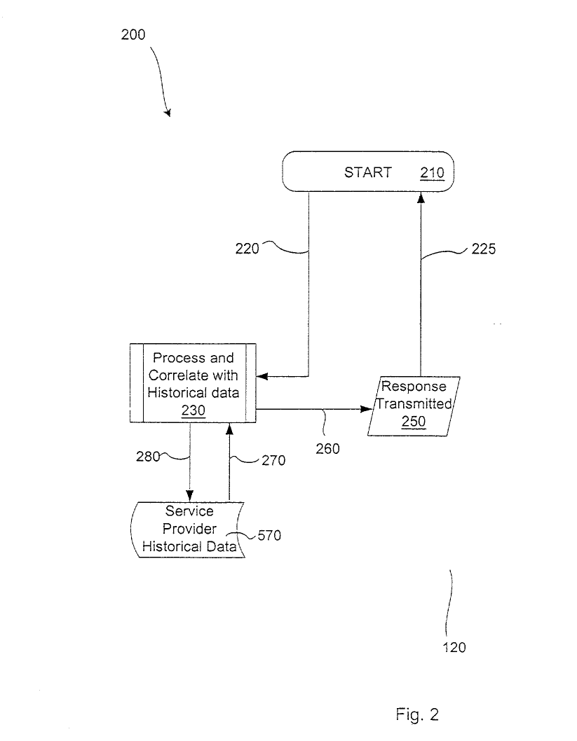

FIG. 2 illustrates a schematic diagram of one process that a consumer 110 (not shown) may use to evaluate one or more service providers 120. The process starts 210 with a consumer 110 (not shown) searching for one specific service provider 130 (not shown), or a set of service providers 130 (not shown) that meet the consumer's requirements for a reservation (step 220). Such requirements can include, but are not limited to, date open, time open, costs, menus, location, reservation availability, and the service provider's reliability rating. The actual process involves the consumer 110 locating one or more specific providers 130 (through a linkage from other information or from a search on the site using the above criteria), then requesting the service providers' historical performance record 240 through the reliability/reservation system (step 280). The system 120 retrieves the specific records (step 270), analyzes the received data to produce a rating for the service provider 130 by a process 230 and provides the rating to a response unit 250 (step 260). Then, the system 120 presents the results to the consumer 110 (step 225). As one skilled in the art will appreciate, the rating may be calculated at the time of the query, or the rating may be calculated prior to the query and stored in a service provider data record 570.

To apply a rating for each service provider 130 the system 120 may utilize data including, but not limited to:

a number of reservations accepted, confirmed and not canceled;

a number of consumer replies indicating “on time” performance;

a number of consumer replies indicating “less than 10 minutes late with table” performance;

a number of consumer replies indicating “less than 15 minutes late with table” performance; and

a number of consumer replies indicating “failure” to have table ready.

The system 120 of the present invention applies a mathematical formula and presents a cumulative rating based on the above-recorded data, which is expressed as single digit letter, or other grade displayed to the consumer 110. One embodiment of a formula used in accordance with the present invention to calculate a reliability rating for a service provider 130 is as follows:

rating=(y+(y₁₀*0.60)+(y₁₅*0.40)−z)/x

In the equation, x is the number of reservations confirmed and affirmed for the service provider 130 and y equals the number of consumer replies. More specifically, y indicates the number of times consumers indicated that they were seated on time, y₁₀ indicates the total number of times consumers indicated they were seated within ten minutes of a reservation, and y₁₅ indicates the total number of times consumers indicated they were seated within 15 minutes of a reservation time. Z indicates the total number of consumer replies where the consumer 110 either did not have a reservation or was seated more than 15 minutes after the reservation. In some embodiments where x is less than or equal to 6, the service provider is indicated as new and no rating is provided.

In some embodiments, the rating number from the previous calculation is converted to a letter grade. For example, letter grades can be provided as follows:

A+ for a rating number greater than or equal to 90

A for a rating number greater than or equal to 89

B for a rating number greater than or equal to 79

C for a rating number greater than or equal to 69

D for a rating number greater than or equal to 59

F for all other rating numbers.

This letter grade can be used by the consumer 110 as an indication of the degree to which it is likely that the service provider 130 will act in accordance with the terms of a reservation.

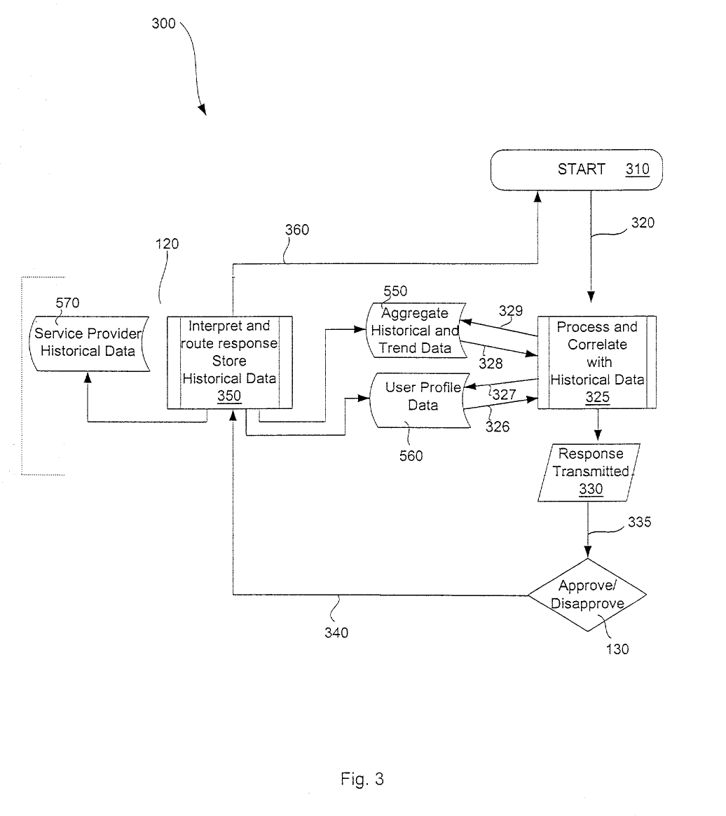

FIG. 3 illustrates a schematic diagram of one process that may be used to negotiate a final reservation commitment. After a consumer 110 has decided on an appropriate service provider 130, the consumer 110 places a reservation assignment request to the reliability/reservation system 120 of the present invention (step 320). A process 325 of system 120 stores the request, retrieves the consumer's historical records (step 326) and reliability rating (step 328), and passes the request via process 330 to the service provider 130 (step 335). Included with the reservation request passed to the service provider 130 is the consumer's reliability rating, which can be a single digit letter grade, representative of a recommendation, which is determined from a cumulative rating based on the historical performance of the consumer 110. One embodiment of a formula used in accordance with the present invention to calculate a reliability rating for a consumer is as follows:

rating=(y+(y₂₀*0.95)−z)/x

In the equation, x is the number of reservations confirmed and affirmed for the consumer 110 and y equals the number of service provider responses. More specifically, y indicates the number of times service providers indicated that the consumer was on time and y₂₀ indicates the total number of times service providers indicated that the consumer arrived within 20 minutes of a reservation. Z indicates the total number of times service providers indicated that the consumer either did not arrive or arrived more than 20 minutes late. In some embodiments where x is less than or equal to 5, the consumer is indicated as new and no rating is provided.

In some embodiments, the rating number from the previous calculation is converted to a letter grade. For example, letter grades can be provided as follows:

A+ for a rating number greater than or equal to 90

A for a rating number greater than or equal to 89

B for a rating number greater than or equal to 79

C for a rating number greater than or equal to 69

D for a rating number greater than or equal to 59

F for all other rating numbers.

This letter grade can be used by the service provider 130 to determine whether or not to grant a reservation request from the particular consumer 110.

Data that may be used to calculate a consumer's reliability rating may include:

a number of reservations affirmed and not canceled by the consumer

a number of service provider replies indicating on time performance

a number of service provider replies indicating less than 20 minutes late performance

a number of service provider replies indicating “no show” performance

The reservation assignment request is transmitted to the service provider 130 selected by the consumer 110 with a tracking code unique to the specified service provider 130 and with instructions on a required response time from the service provider 130. The response time instructions are dictated by the period between initiation of the reservation assignment request and the requested date and time of the reservation. The central site system 120 then sets one or more timers for the required response time. The response times may be variable and may depend upon the current time, time zone differences, if any, the operating hours of the service provider 130, and the time period between the reservation assignment request and the time the reservation requested. In some embodiments, failure of a service provider 130 to respond to a reservation request within an allotted time triggers automated reminders to the service provider 130, initially through electronic mail and escalating to manual intervention/review.

The service provider 130, upon receipt of the reservation assignment request with a reliability consumer rating, makes a determination as to whether to accept, reject or propose an alternative recommendation to the consumer. This response from the service provider is delivered to the reliability/reservation system (step 340). The system 120 stores the response time and response answer in a consumer record and a service provider record for later analysis and follow up timers (step 350). Then the system 120 responds back to the consumer 110 with approval, disapproval or a proposed alternative recommendation (step 360), based on the response from the service provider 130.

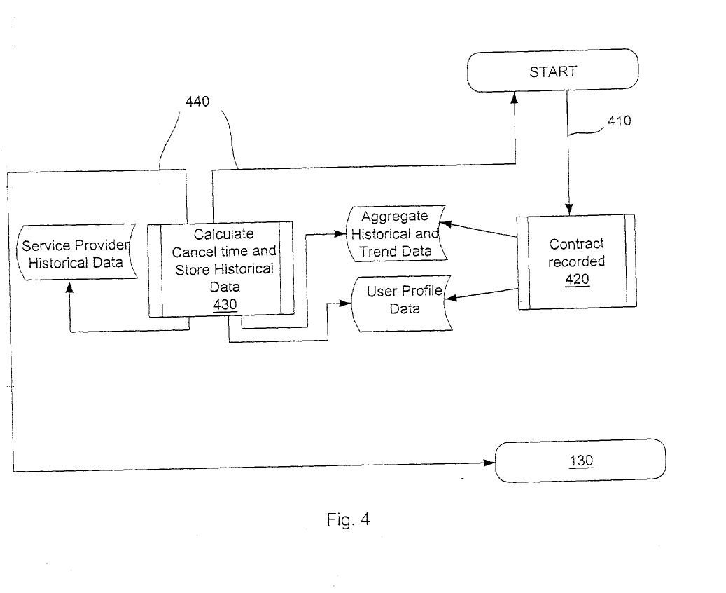

If the reservation assignment request is confirmed, the process continues with the process as portrayed in FIG. 4. If the consumer reservation is disapproved, the process is terminated and the service provider's account is flagged. If an alternative date was requested the process records are purged and a new reservation assignment request is handled as a new reservation request.

Referring now to FIG. 4, the process of completing a reservation illustrated. Once a service provider 130 and a consumer 110 have agreed upon an acceptable date and time for a reservation, the consumer 110 affirms the approval from the service provider 120 (step 410), which is then recorded in the reliability/reservation system 120 (step 420). At this point, both parties are bound by a reservation contract. After the reservation contract is finalized, the system 120 calculates a latest permissible cancellation date and time (step 430). In accordance with one embodiment of the present invention, the cancellation date and time may be based on the date and time of the reservation contract minus eight hours of time falling within the administrative open time as provided by the service provider 130. This calculated cancellation date and time is shown on a voucher that bears a number unique to the reservation contract. The voucher then may be sent from the system 120 to both the consumer 110 and the service provider 130 (step 440). The consumer 110 may then be prompted to print the reservation voucher, which may contain data, such as confirmation number, name and identifying information of the service provider, number in party, date and time of reservation, maps or directions to the service provider's location, parking vouchers or passes, and so on. The service provider 130 may print one or more or the reservation vouchers, or may download the reservation/voucher information to a table or facility management computer software application.

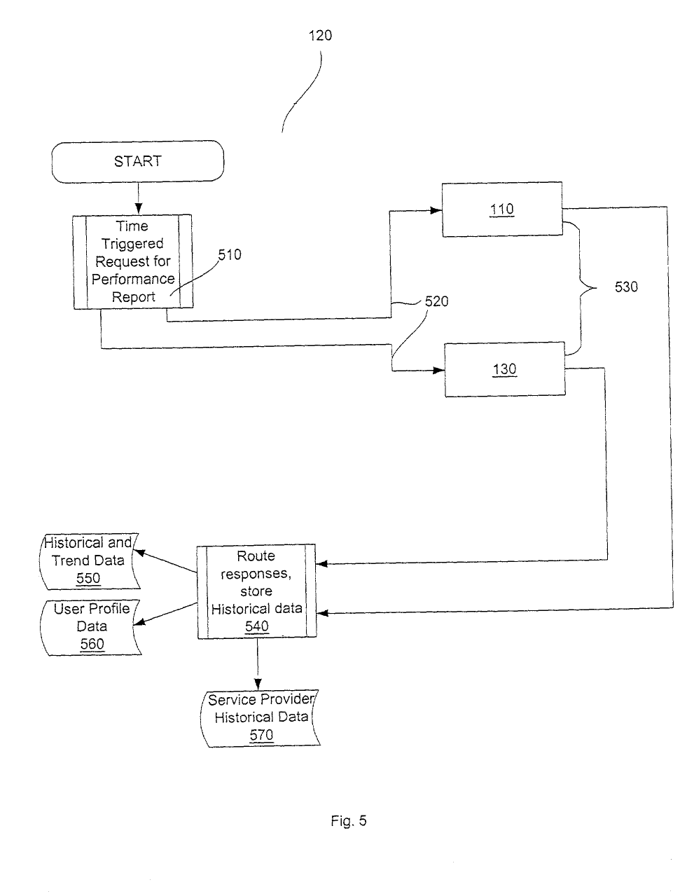

FIG. 5 illustrates one embodiment of a method for obtaining reliability and other satisfaction data from consumers 110 and service providers 130. In accordance with the illustrated embodiment, a process 510 monitors the reservation and upon expiration of the reservation commitment time and date, a request for performance is sent to both the consumer 110 and the service provider 130 of the associated reservation (step 520). The request for performance elicits data input from each party relating to the performance of the corresponding party in the referenced reservation assignment (step 530). The data received from the parties preferably comprises data that is used by the mathematical formulas for determining ratings as described above. Data received from the consumers 110 and service providers 130 is interpreted by the system's mathematical models. In accordance with this aspect of the present invention, the system 120 extracts the relevant historical data for the consumer 110 and/or service provider 130 from one or more suitable databases (step 540). The system 120 also takes the response data received from consumers 110 and service providers 130 and uses it with the historical data to calculate new reliability values/grades for the consumer 110 and the service provider 130. The new information then is stored in the one or more databases (step 540). In some embodiments, the databases include, but are not limited to, historical and trend data 550, user profile data 560, and service provider historical data 570.

User profile data 560 includes information associated with a particular consumer 110. For example, user profile data 560 can include, but is not limited to the consumer's rating, data used to compute the consumer's rating, what type of food and/or drinks the consumer 110 orders, the average amount of time the consumer 110 spends dining, the average amount of money spent on a meal by the consumer, and other such information.

Service provider historical data 570 includes information associated with a particular service provider 130. For example, service provider historical data 570 can include, but is not limited to, a rating associated with the particular service provider 130, data used to calculate the rating associated with the service provider 130, menus offered by the service provider 130 and other such information.

Historical and trend data 570 includes a combination of information associated with an entire industry. For example, the historical and trend data can include, but is not limited to, average delay before being seated created from data from all service providers 130, the average time difference between when a consumer arrives and the agreed reservation time, an indication of what time of day the delays will be most significant, whether the delay time is trending up or down, and other such information.

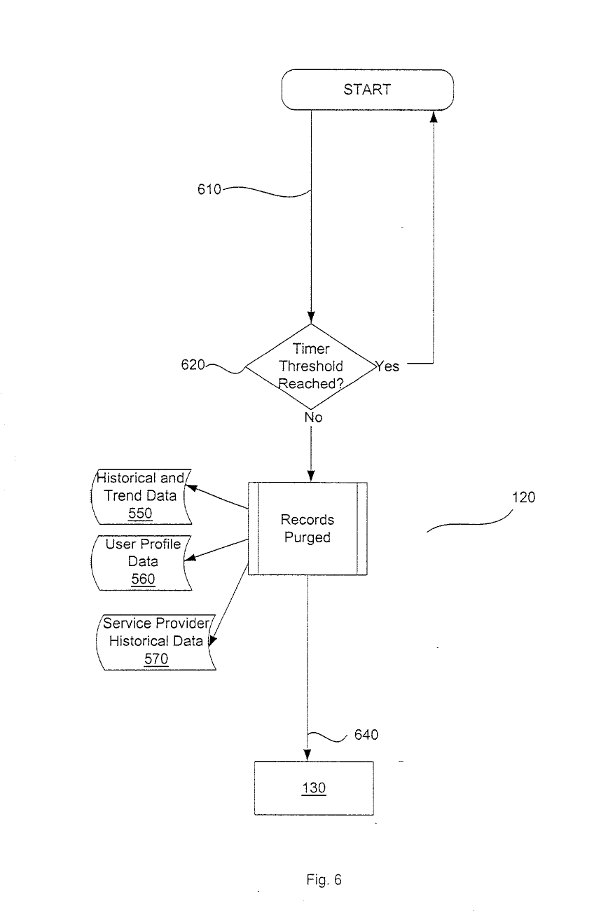

Referring now to FIG. 6, one embodiment of a method for canceling a reservation is illustrated. In accordance with this aspect of the present invention, a consumer 110 can cancel a reservation at any time prior to the calculated cancellation time/date deadline, which is discussed above. To cancel a reservation, a consumer 110 may communicate with the reliability/reservation system 120 the consumer's wish to cancel a reservation contract (610). The consumer 110 may communicate a cancellation request to the system 120 by sending an email, by accessing the system 120 using an internet browser, by calling the system 120, or any other communication means. Upon receiving a cancellation request, the system 120 compares the date and time of the consumer's cancellation request to the calculated cancellation time deadline (step 620). If the cancellation request is prior to the cancellation request deadline, the request will be successful, and the system 120 will generate a cancellation number unique to the reservation contract (step 630). Records of the canceled reservation are then purged (step 630). E-mail messages may be used to communicate confirmation of the canceled reservation to the service provider and the consumers (step 640). Such e-mail message would constitute a cancellation voucher/verification.

In light of the preceding discussion, many advantages and benefits of the present invention are evident. For example, service providers and/or consumers can be apprised of the likelihood that a reservation contract will be observed. Many other such advantages are also apparent, for example, various embodiments do not include any transfer of sensitive information, such as, credit card information. Because of this, the present invention avoids the need to encrypt information for transfer. Of course, it should be recognized that such encryption can be added to the present invention within the scope of the appended claims.

Also, it should be recognized that other information about a user and or service provider can be provided according to the present invention. For example a user's present location can be provided to the system and incorporated in the user's reliability rating. More specifically, a user within five miles of the service providers location and requesting a reservation in the immediate future may be rated highly reliable. In contrast, a user fifty miles away requesting an immediate reservation may be considered highly unreliable. Such location information can be garnered automatically using GPS based devices or manually by asking the user where they are at.

In conclusion, the present invention provides a novel system and method for determining the reliability of consumers and service providers, and for obtaining reservations based on those reliabilities. While a detailed description of presently preferred embodiments of the invention has been given above, various alternatives, modifications, and equivalents will be apparent to those skilled in the art. Therefore, the above description should not be taken as limiting the scope of the invention, which is defined by the appended claims.

What is claimed is:

1. A method for determining the reliability of a consumer and/or a service provider, the method comprising:
obtaining reliability data for a first entity from at least a second entity;
using a central computer system, calculating a reliability factor based on the reliability data; and
communicating the reliability factor to a third entity.

2. The method of claim 1, wherein the first entity is a user, the second entity is a first service provider and the third entity is a second service provider.

3. The method of claim 1, wherein the first entity is a service provider, the second entity is a first user and the third entity is a second user.

4. The method of claim 1, the method further comprising:
receiving a request to reserve an item of inventory associated with the third entity.

5. The method of claim 4, wherein the first entity is a user and the third entity is a service provider.

6. The method of claim 5, wherein the service provider is a restaurant and the item of inventory is a table in the restaurant.

7. The method of claim 4, wherein the first entity is a user, the second entity is a first restaurant and the third entity is a second restaurant, the method further comprising:
obtaining an amount spent by the user at the first restaurant;
obtaining an amount spent by the user at the second restaurant;
calculating an average amount spent at a restaurant by the user, wherein the average amount spent at a restaurant by the user is derived, at least in part, from the amount spent by the user at the first restaurant and the amount spent by the user at the second restaurant; and
communicating the average amount spent at a restaurant by the user to the second restaurant.

8. The method of claim 4, the method further comprising:
communicating the request to reserve the item of inventory to the third entity; and
receiving an acceptance from the third entity allowing the user to reserve the item of inventory.

9. A system for determining the reliability of a consumer and/or a service provider, the system comprising:
a central computer system, wherein the central computer system is associated with a database, and wherein the database comprises a first reliability factor associated with a service provider and a second reliability factor associated with a consumer;
wherein the first reliability factor is derived from input from a first plurality of entities and the second reliability factor is derived from input from a second plurality of entities; and
wherein the computer system is accessible to both the consumer and the service provider.

10. The system of claim 9, wherein the first plurality of entities comprises a group of consumers and the second plurality of entities comprises a group of service providers.

11. The method of claim 10, Wherein the group of service providers is a group of restaurants.

12. A method for assigning table reservations in a restaurant, the method comprising:
receiving a request for a table reservation, wherein the request for a table reservation is associated with a user;
receiving a reliability factor associated with the user from a computer system, wherein input from a plurality of restaurants is used to derive the reliability factor; and
accepting the request for a table reservation based at least in part on the reliability factor.

13. The method of claim 12, the method further comprising:
providing input to the computer system, wherein the input comprises information about whether the user honored the table reservation.

14. The method of claim 13, wherein the input is provided across a computer network.

15. The method of claim 12, the method further comprising:
receiving a characteristic associated with the user from the computer database, wherein the characteristic indicates an average amount spent by the user.

16. The method of claim 15, wherein accepting the request for a table reservation is based at least in part on the characteristic.

17. The method of claim 12, wherein the reliability factor is received across a computer network.

18. A method for assigning reservations for inventory maintained by a service provider, the method comprising:
receiving a request to reserve an inventory item from a user;
providing the request to reserve the inventory item to a service provider associated with the inventory item;
providing a reliability factor associated with the user from a computer system, wherein the reliability factor is derived from input from a plurality of service providers; and
receiving a response to the request to reserve the inventory item from the service provider.

19. The method of claim 18, wherein the inventory item is table space in a restaurant.

20. The method of claim 18, wherein the plurality of service providers are a plurality of restaurants.

21. The method of claim 18, wherein the response to the request is an acceptance, and wherein a reservation contract is formed.

22. The method of claim 21, the method further comprising:
receiving a cancellation request from the user, wherein the cancellation request cancels the reservation contract; and
wherein the reliability factor is not affected.

23. The method of claim 21, the method further comprising:
receiving an indication that the reservation contract was breached; and
modifying the reliability factor to incorporate the breach.
